(19) United States
(12) Patent Application Publication
(10) Pub. No.: US 2025/0035526 A1
(43) Pub. Date: Jan. 30, 2025

(54) DEVICE FOR DETERMINING A PROPERTY OF A LIQUID COMPONENT OF A GAS-LOADED MEDIUM

(71) Applicant: Endress+Hauser Flowtec AG, Reinach (CH)

(72) Inventors: Andreas Güttler, Zolling (DE); Helmut Zeislmeier, Freising (DE); Ralf Schweigler, Steinen / Höllstein (DE)

(21) Appl. No.: 18/716,654

(22) PCT Filed: Nov. 21, 2022
(86) PCT No.: PCT/EP2022/082636

§ 371 Date: Jun. 5, 2024

(30) Foreign Application Priority Data
Dec. 14, 2021 (DE) 10 2021 131 150.1

(51) Int. Cl. G01N 9/00

(52) U.S. Cl. CPC G01N 9/002

(57) ABSTRACT

The invention relates to a device for determining a property of a liquid component of a gas-loaded medium comprising a pipeline for conducting the medium with a first section, wherein the first section has an inclination of less than 20° and a second section in the form of a riser, wherein the second section forms an angle of at least 45° with respect to a horizontal, characterized in that a closed end is arranged in an extension of the first section. A connection of the second section to the first section defines a beginning of the closed end, and at least one measuring device for measuring the property of the liquid component is arranged in an end region of the closed end.

The invention relates to a device for determining a property of a liquid component of a gas-loaded medium, such as a density.

Measuring the property of the liquid component of a gas-loaded medium is a major challenge in terms of measurement technology. For example, as shown in WO2010129603A2, a Coriolis measuring device is used for this purpose. However, drawing conclusions from measured measuring tube vibrations to a property of the liquid component is fraught with difficulties.

Therefore, the object of the invention is to propose a device by means of which a property of the liquid component of a gas-loaded medium can be determined robustly and simply.

The object is achieved by a device according to independent claim 1.

A device according to the invention for determining a property of a liquid component of a gas-loaded medium comprises

a pipeline for conducting the medium with
a first section, wherein the first section has an angle of less than 20° and in particular less than 10° with respect to a horizontal.
a second section in the form of a riser, wherein the second section forms an angle of at least 45° with respect to a horizontal,

characterized in that a closed end is arranged in an extension of the first section,

wherein a connection of the second section to the first section defines a beginning of the closed end,

wherein at least one measuring device for measuring the property of the liquid component is arranged in an end region of the closed end.

Due to a slowing down of the flow, a separation of the liquid component and the gas component takes place locally in the end region, so that a measurement of the property of the liquid component can be carried out without a significant influence by the gas loading of the medium.

In one embodiment, the closed end has an inclination in the direction of gravity, wherein the inclination has an angle relative to the horizontal of at least 2° and in particular at least 4° and at most 15° and in particular at most 10°.

In this way, an accumulation of gas in the region of the closed end can be prevented.

In one embodiment, a bypass line is provided, which is configured to connect the end region of the closed end to the second section.

In this way, an accumulation of gas in the region of the closed end can be discharged via the bypass line.

In one embodiment, the bypass line has a valve which is configured to adjust a bypass flow.

In this way, the flow in the closed end can be adjusted in such a way that, on the one hand, the gas loading of the medium in the closed end is low and, on the other hand, there is sufficient exchange of the medium, so that measured values of the property represent a current state of the medium.

In one embodiment, the closed end has a locking device by means of which the end region of the closed end can be separated fluidically.

As a result, it is possible to clean the end region without interrupting the flow of the medium through the pipeline.

In one embodiment, the second section has a flow constriction, wherein the bypass line connects to the second section in the region of the flow constriction.

As a result, a negative pressure is created in the region of an outlet of the bypass line, as a result of which the flow of the medium through the bypass line is supported.

In one embodiment, the closed end has an inclination in the opposite direction to gravity, wherein the inclination has an angle relative to the horizontal of at least 2° and at most 10°.

As a result, an accumulation of gas can be better absorbed and discharged by separating the liquid and gas components through the bypass line.

In one embodiment, the closed end has an arc-shaped section that, in a projection onto a horizontal plane, forms an arc angle of 90° with respect to an arc center. In general, the formed angle is at least 45° and in particular at least 60° and preferably at least 75°. The arc-shaped section is arranged between the connection and the bypass line. The flow of the medium towards the bypass line experiences a centrifugal force in the arc-shaped section, which leads to improved separation of the liquid and gas components.

In one embodiment, the closed end has a cleaning device by means of which a lumen of the closed end can be cleaned.

As a result, the continuous operation of the measuring device for measuring the media property is ensured.

In one embodiment, the cleaning device has an ultrasonic transducer for generating ultrasound or a flushing ring.

Ultrasonic waves can be used to remove deposits and dirt from an inner wall. By means a flushing ring, deposits and dirt can be flushed away.

In both cases, the deposits and dirt can be fed into the second section of the pipeline.

In one embodiment, a dirt trap is configured in an initial region of the closed end, which dirt trap has a recess, for example.

The dirt trap prevents contamination of the measuring device.

In one embodiment, the measuring device is a density meter and has a vibrometer and/or a microwave transceiver and/or an ultrasonic transducer.

The invention will now be described with reference to exemplary embodiments.

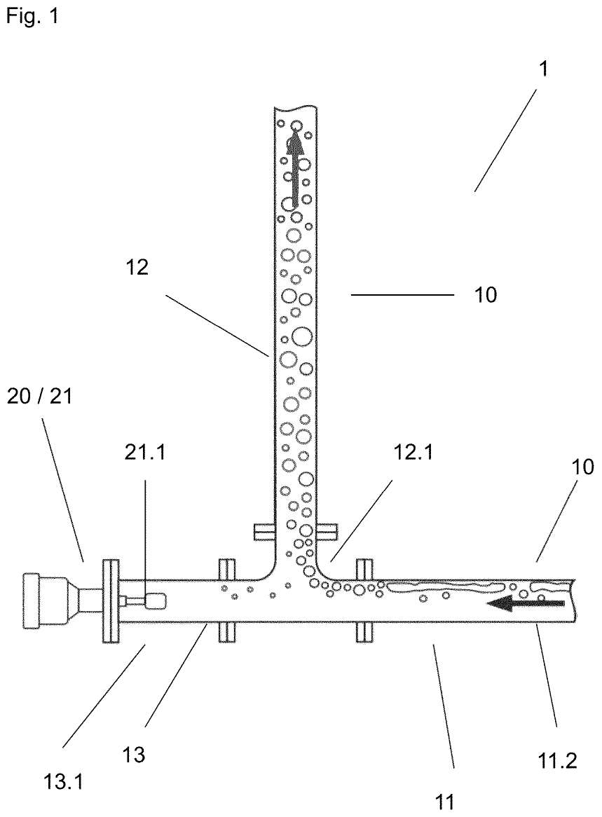

FIG. 1 shows an exemplary embodiment of the device according to the invention.

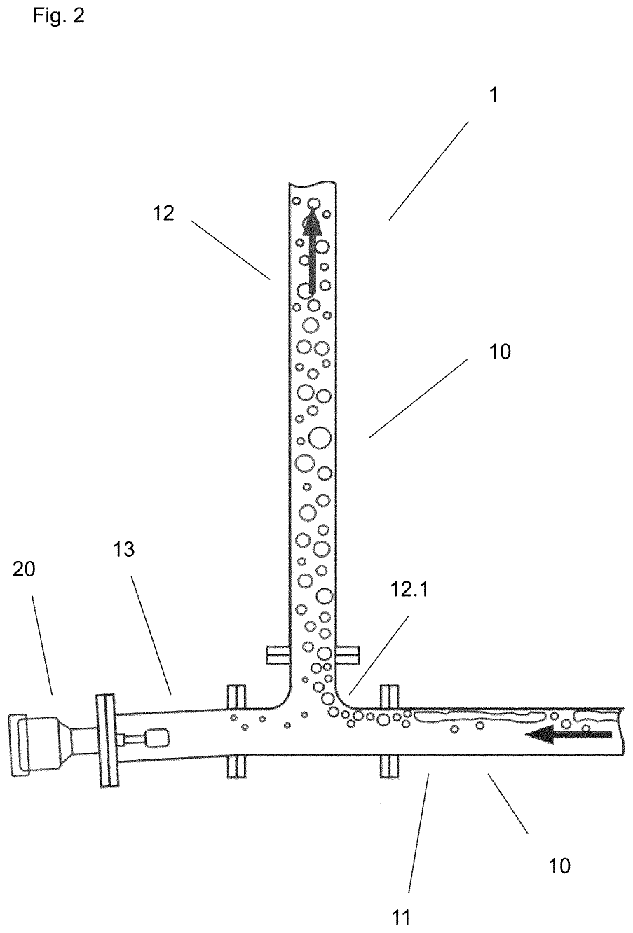

FIG. 2 shows an exemplary embodiment of the device according to the invention.

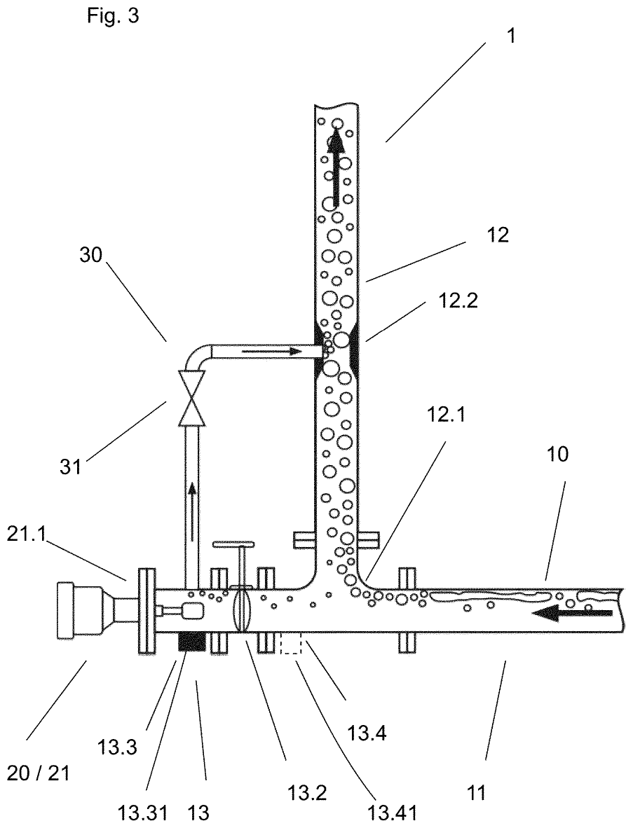

FIG. 3 shows an exemplary embodiment of the device according to the invention.

FIG. 1 shows an embodiment of the device 1 comprising a pipeline 10 with a first section 11 and a second section 12 in the form of a riser. The first section is configured to hold a medium that is sometimes loaded with gas. In an extension of the first section, the device has a closed end 13, in which a measuring device 20 for detecting a property of a liquid component of the medium is arranged according to the invention. For example, the measuring device can be a density meter 21 as shown here. For example, the density meter can have a vibrometer 21.1 as shown here. Alternatively, the density meter can also have a microwave transceiver or an ultrasonic transducer.

The second section 12 forms an angle of at least 45° with a horizontal, which can be 90°, for example, as shown here, so that the second section runs vertically. A connection 12.1 of the second section to the first section defines a beginning of the closed end 13.

Given that the closed end is flow-calmed, a separation of the liquid and gas components of the medium takes place, so that the property of the liquid component can be measured without being significantly influenced by the gas loading of the medium.

FIG. 2 shows an embodiment of the device as shown in FIG. 1, wherein the closed end 13 has an inclination in the direction of gravity,

wherein the inclination has an angle relative to the horizontal of at least 2° and in particular at least 4° and at most 15° and in particular at most 10°. In this way, an accumulation of gas in the region of the closed end can be prevented.

FIG. 3 shows an embodiment of the device shown in FIG. 1, wherein a bypass line 30 is provided, which is configured to connect the end region 13.1 of the closed end 13 to the second section 12. In this way, an accumulation of gas in the region of the closed end can be discharged via the bypass line.

As shown here, the bypass line can have a valve 31, by means of which a flow through the bypass line can be adjusted. In this way, the flow in the closed end can be adjusted in such a way that, on the one hand, the gas loading of the medium in the closed end is low and, on the other hand, there is sufficient exchange of the medium, so that measured values of the property represent a current state of the medium.

The second section 12 of the pipeline can have a flow constriction 12.2 as shown here, wherein a connection of the bypass line 30 to the second section falls within the region of the flow constriction. As a result, a negative pressure is created in the region of an outlet of the bypass line, as a result of which the flow of the medium through the bypass line is supported.

In one embodiment, the closed end has a locking device by means of which the end region of the closed end can be separated fluidically. As a result, it is possible to clean the end region, at least in sections, without interrupting the flow of the medium through the pipeline.

In contrast to what is shown here, the closed end can have an inclination in the opposite direction to gravity, wherein the inclination has an angle relative to the horizontal of at least 2° and at most 15°. As a result, an accumulation of gas can be better absorbed and discharged by separating the liquid and gas components through the bypass line.

In one embodiment, the closed end has a cleaning device by means of which a lumen of the closed end can be cleaned. As a result, the continuous operation of the measuring device for measuring the media property is ensured. The cleaning device 13.3 can, for example, have an ultrasonic transducer 13.31 for generating ultrasound or a flushing ring. By means of ultrasonic waves, deposits or contamination from an inner wall can be loosened and removed. By means of a flushing ring, the closed end can be flushed with a flushing fluid.

In one embodiment, the closed end can have a dirt trap 13.4, which is designed as a recess as outlined here. For example, the dirt trap can be fastened and removed using simple mechanical fasteners such as screws. In this way, it is easy to remove dirt from the closed end.

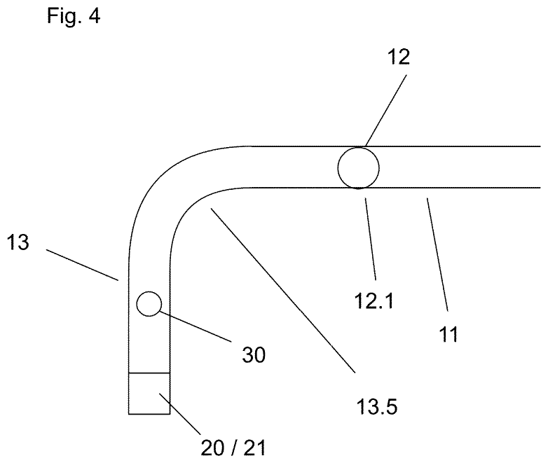

FIG. 4 outlines an embodiment of the device according to FIG. 3, wherein the closed end 13 has an arc-shaped section 13.5 that, in a projection onto a horizontal plane, forms an arc angle of 90° with respect to an arc center. In general, the formed angle is at least 45° and in particular at least 60° and preferably at least 75°. The arc-shaped section is arranged between connection 12.1 of the second section 12 and bypass line 30. The flow of the medium towards the bypass line experiences a centrifugal force in the arc-shaped section, which leads to improved separation of the liquid and gas components.

All the features shown in FIGS. 1 to 4 can be combined, provided they are not mutually exclusive.

### LIST OF REFERENCE SIGNS

1 Device
10 Pipeline
11 First section
12 Second section
12.1 Connection
12.2 Flow constriction
13 Closed end
13.1 End region
13.2 Locking device
13.3 Cleaning device
13.31 Ultrasonic transducer
13.4 Initial region
13.41 Dirt trap
13.5 Arc-shaped section
20 Measuring device
21 Density meter
21.1 Vibrometer
30 Bypass line
31 Valve

1. A device (1) for determining a property of a liquid component of a gas-loaded medium comprising:
a pipeline (10) for conducting the medium with
a first section (11), wherein the first section has an angle of less than 20° and in particular less than 10° with respect to a horizontal.
a second section (12) in the form of a riser, wherein the second section has an angle of at least 45° with respect to a horizontal,
characterized in that a closed end (13) is arranged in an extension of the first section,
wherein a connection (12.1) of the second section to the first section defines a beginning of the closed end,
wherein at least one measuring device (20) for measuring the property of the liquid component is arranged in an end region (13.1) of the closed end.

2. The device according to claim 1,
wherein the closed end (13) has an inclination in the direction of gravity,
wherein the inclination has an angle relative to the horizontal of at least 2° and in particular at least 4° and at most 15° and in particular at most 10°.

3. The device according to claim 1,
wherein a bypass line (30) is provided, which is configured to connect the end region (13.1) of the closed end (13) to the second section (12).

4. The device according to claim 3,
wherein the bypass line (30) has a valve (31), which is configured to adjust a bypass flow.

5. The device according to either claim 3 or claim 4,
wherein the closed end (13) has a locking device (13.2), by means of which the end region (13.1) of the closed end can be fluidically separated.

6. The device according to any of claims 3 to 5,
wherein the second section (12) has a flow constriction (12.2), wherein the bypass line (30) connects to the second section in the region of the flow constriction.

7. The device according to any of claims 3 to 6,
wherein the closed end (13) has an inclination in the opposite direction to gravity,
wherein the inclination has an angle relative to the horizontal of at least 2° and at most 10°.

8. The device according to any of claims 3 to 7,
wherein the closed end has an arc-shaped section (13.5) that, in a projection onto a horizontal plane with respect to an arc center, forms an arc angle of at least 45° and in particular at least 60° and preferably at least 75°,
wherein the arc-shaped section is arranged between the connection 12.1 and the bypass line 30.

9. The device according to any of the preceding claims,
wherein the closed end (13) has a cleaning device (13.3), by means of which a lumen of the closed end can be cleaned.

10. The device according to claim 9,
wherein the cleaning device (13.3) has an ultrasonic transducer (13.33) for generating ultrasound or a flushing ring.

11. The device according to any of the preceding claims,
wherein a dirt trap (13.41) is configured in an initial region (13.4) of the closed end, which dirt trap has, for example, a recess.

12. The device according to any of the preceding claims,
wherein a measuring device (20) is a density meter (21) and has a vibrometer (21.1) and/or a microwave transceiver and/or an ultrasonic transducer.
